(19) United States
(12) Patent Application Publication
(10) Pub. No.: US 2015/0177376 A1
(43) Pub. Date: Jun. 25, 2015

(54) ATMOSPHERIC RADAR

(71) Applicant: BROOKHAVEN SCIENCE ASSOCIATES LLC, UPTON, NY (US)

(72) Inventor: Michele Galletti, Ridge, NY (US)

(73) Assignee: BROOKHAVEN SCIENCE ASSOCIATES LLC, UPTON, NY (US)

(21) Appl. No.: 14/405,720

(22) PCT Filed: Jun. 19, 2013
(86) PCT No.: PCT/US13/46578

§ 371 Date: Dec. 4, 2014

Related U.S. Application Data
(60) Provisional application No. 61/663,209, filed on Jun. 22, 2012.

(51) Int. Cl. G01S 13/95; G01S 7/04

(52) U.S. Cl. CPC G01S 13/95; G01S 7/04

(57) ABSTRACT

Technologies are described effective to implement an atmospheric radar system. An antenna array transmits a wave toward an atmospheric target and receives a reflected wave that includes voltages corresponding to backscattered radar signal measurements. A processor includes a coherency matrix generator module effective to receive the voltages and generate a coherency matrix. The processor further includes an eigenvalue calculator module effective to receive the coherency matrix and calculate eigenvalues of the coherency matrix The processor includes an eigenvalue variable calculator module effective to receive the eigenvalues and calculate eigenvalue meteorological variables from the eigenvalues. The processor further includes an atmosphere display module effective to receive the eigenvalue meteorological variables and generate an output signal that corresponds to the meteorological property of the atmospheric target in response.

### CROSS REFERENCE TO RELATED APPLICATIONS

This application claims priority to U.S. provisional application 61/663,209 filed Jun. 22, 2012, entitled “EIGEN VALUE SIGNAL PROCESSING FOR ATMOSPHERIC RADARS”, the entirety of which is hereby incorporated by reference.

### STATEMENT OF GOVERNMENT RIGHTS

The present application was made with government support under contract number DE-AC02-98CH10886 awarded by the U.S. Department of Energy. The United States government has certain rights in the invention(s).

### FIELD OF THE INVENTION

This application relates to radar signal processing and, more particularly, to eigenvalue signal processing for atmospheric radars.

### BACKGROUND

In atmospheric radars, an antenna may be used to transmit a radar wave toward a target. The target may modify and reflect the transmitted wave to produce a reflected or backscattered wave. The reflected wave may be processed to determine meteorological properties of the target.

### SUMMARY OF THE INVENTION

A method of generating an output signal. corresponding to a meteorological property of an atmospheric target. The method may include, by a processor, receiving voltages that correspond to backscattered radar signal measurements of the atmospheric target from an antenna. The method may further include generating a coherency matrix from the voltages. The method may further include calculating eigenvalues of the coherency matrix. The method may further include calculating eigenvalue meteorological variables from the eigenvalues. The method may further include generating the output signal that corresponds to the meteorological property of the atmospheric target in response to the calculated eigenvalue meteorological variables.

A programmable circuit effective to generate an output signal that corresponds to a meteorological property of an atmospheric target. The programmable circuit may include a coherency matrix generator module effective to receive voltages that correspond to backscattered radar signal measurements of the atmospheric target from an antenna. The programmable circuit may include an eigenvalue calculator module effective to receive the coherency matrix and calculate eigenvalues of the coherency matrix. The programmable circuit may include an eigenvalue variable calculator module effective to receive the eigenvalues and calculate eigenvalue meteorological variables from the eigenvalues. The programmable circuit may include an atmosphere display module effective to receive the eigenvalue meteorological variables and generate the output signal that corresponds to the meteorological property of the atmospheric target in response.

An atmospheric radar system comprising an antenna array effective to transmit a wave toward an atmospheric target and receive a reflected wave in response. The reflected wave includes voltages that correspond to backscattered radar signal measurements. The atmospheric radar system may include a display and a processor configured to be in communication with the antenna array and the display. The processor may include a coherence matrix generator module effective to receive the voltages and generate a coherency matrix. The processor may further include an eigenvalue calculator module effective to receive the coherency matrix and calculate eigenvalues of the coherency matrix. The processor may further include an eigenvalue variable calculator module effective to receive the eigenvalues and calculate eigenvalue meteorological variables from the eigenvalues. The processor may further include an atmosphere display module effective to receive the eigenvalue meteorological variables and generate an output signal that corresponds to the meteorological property of the atmospheric target based on the calculated eigenvalue meteorological variables. The display may be effective to receive the output signal and generate a displayed radar image in response.

The foregoing summary is illustrative only and is not intended to be in any way limiting. In addition to the illustrative aspects, embodiments, and features described above, further aspects, embodiments, and features will become apparent b reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1(a) is a prior an graphical representation of incoherent cross-polar power appearing at four offset lobes of an antenna used in a weather radar;

FIG. 1(b) is a prior art graphical representation of coherent cross-polar power appearing as a coaxial lobe of an antenna used in a weather radar;

FIG. 2 illustrates an example of a system that can be utilized to implement an atmospheric radar; and

FIG. 3 depicts a flow diagram for an example of a process for implementing an atmospheric radar;

all arranged according to at least some embodiments described herein.

### DETAILED DESCRIPTION

In the following, detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described. herein, and illustrated in the Figures, can be arranged, substituted, combined, separated, and designed in a wide variety of different configurations all of which are explicitly contemplated herein.

The present disclosure provides an atmospheric radar that uses eigenvalue signal processing as a solution for the problem of antenna cross-polarization isolation. The atmospheric radar is able to eliminate the coherent cross-polar power bias for the following variables in use in weather/atmospheric radar polarimetry: reflectivity at horizontal transmit (Z_{H}), reflectivity at vertical transmit (Z_{V}), reflectivity at circular polarization transmit (Z_{C}), differential reflectivity (Z_{DR}), Linear Depolarization Ratio at horizontal transmit (LDR_{H}), Linear Depolarization Ratio at vertical transmit (LDR_{V}), and Circular Depolarization Ratio (CDR).

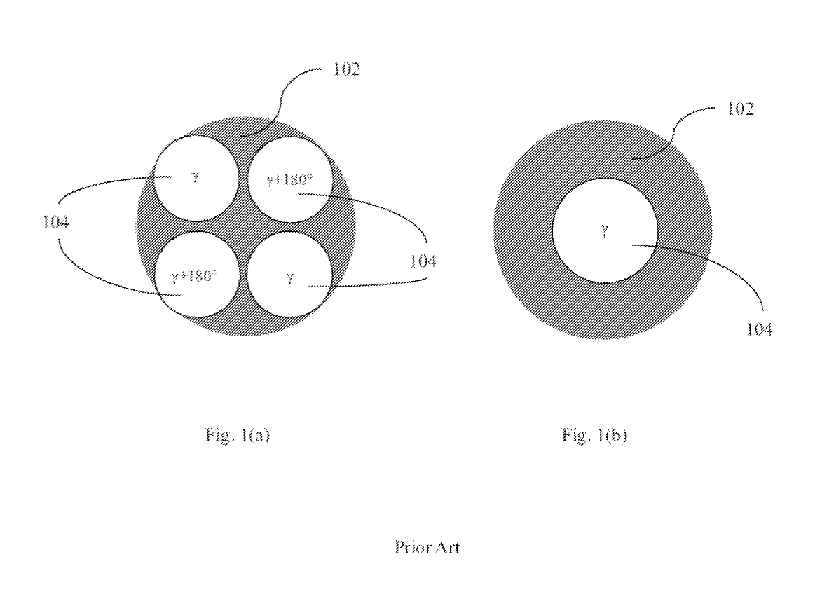

In general, the unwanted cross-polar power radiated by the antenna can be split into two components: the incoherent cross-polar power, and the coherent cross-polar power. FIG. 1(a) is a graphical representation of the incoherent cross-polar power appearing as four (4) offset lobes, and FIG. 1(b) is a graphical representation of the coherent cross-polar power appearing as a coaxial lobe. The circle in grey 102 represents an iso-power contour of the copolar main lobe, white circles 104 represent iso-power contours of cross-polar lobes. The phase of the copolar lobe is taken as the reference. The parameter γ in FIG. 1(a) represents the phase difference between the copolar main lobe and two of the cross-polar lobes, and the parameter γ in FIG. 1(b) represents the phase difference between the copolar main lobe and the cross-polar coaxial lobe. The cross-polar phase γ is in general equal to 0.

The incoherent cross-polar power generally appears as a quad of offset lobes, and is produced by the natural geometry of the electric field lines on the radiating surface of the antenna. The quad of offset cross-polar lobes is present in parabolic reflectors as well as in microstrip patch antennas. When a cloud of spheres is illuminated, such quad of offset lobes produces backscattered cross-polar power that is uncorrelated with the backscattered copolar power. In this situation, the cross-polar correlation coefficient, which is represented by ρₓₕ defined in Equation (6) below, is equal to zero.

The coherent cross-polar power appears as a coaxial lobe, aligned with the boresight of the antenna. Such coaxial cross-polar power is generated by a number of sources. In the case of parabolic reflectors, it can be generated by imperfections in the reflector surface, feed-horn misalignment, or scattering from the feed support struts. In the case of a planar phased array scanning off the horizontal and vertical planes, it is generated by the misalignment of the radiated field lines with respect to the local horizontal. The coherent cross-polar power significantly increases the cross-polar correlation coefficient, but the bias the coherence cross-polar power introduces in polarimetric radar meteorological variables can be removed by the eigenvalue signal processing in this disclosure.

The matrix multiplication representing the effects of a non-ideal antenna is modeled as a congruence transformation:

$${S}^{′} = {F}^{t} SF = [ \begin{matrix}{F}_{hh} & {F}_{x} \\ {F}_{x} & {F}_{vv}\end{matrix} ] [ \begin{matrix}{s}_{hh} & {s}_{hv} \\ {s}_{vh} & {s}_{vv}\end{matrix} ] [ \begin{matrix}{F}_{hh} & {F}_{x} \\ {F}_{x} & {F}_{vv}\end{matrix} ] \qquad ( 1 )$$

where

S represents the complex voltages received by a radar;

F represents the one-way voltage antenna pattern;

h represents horizontal polarization;

v represents vertical polarization; and

x represents cross-polarization (hv and vh).

Since eigenvalues are invariant for congruence transformations (such as those on (1)), eigenvalue-derived variables may be robust with respect to coherent antenna cross-channel coupling. The eigenvalue-derived variables are unbiased even if there is the coherent antenna cross-channel coupling. The eigenvalue-derived variables are numerically equal to the corresponding traditional radar meteorological variables, when assuming there is no bias induced by the coherent cross-polar power. As such, the eigenvalue-derived variables represent an ideal situation of an antenna without the coherent cross-channel coupling.

The eigenvalue-derived variables may be based on target reflection. symmetry. Under the assumption of target reflection symmetry, standard radar meteorological variables, also called weather radar data products, can be replaced by new eigenvalue-derived variables, indicated with a subscript nought:

Z_{H}→Z_{H0}

Z_{V}→Z_{V0}

Z_{C}→Z_{C0}

Z_{DR}→Z_{DR0}

LDR_{H}→LDR_{H0}

LDR_{V}→LDR_{V0}

CDR→CDR₀ (2)

The subscript nought indicates the assumption of target reflection symmetry, for which the cross-polar correlation coefficient is 0. In the disclosed method, if the actually measured cross-polar correlation coefficient is positive, the cross-polar correlation coefficient may be attributed to the coherent cross-polar power leaking from the antenna.

Dual-pot radars transmitting horizontal polarization measure the coherency matrix at horizontal polarization transmit (J_{H}), that corresponds to the upper left 2×2 minor of the backscatter covariance matrix:

$${J}_{H} = [ \begin{matrix}〈 {\vert {s}_{hh} \vert}^{2} 〉 & 〈 {s}_{hh}^{*} {s}_{vh} 〉 \\ 〈 {s}_{hh} {s}_{vh}^{*} 〉 & 〈 {\vert {s}_{vh} \vert}^{2} 〉\end{matrix} ] \qquad ( 3 )$$

sₕₕ and sᵥₕ are radar measurements of a detected target of a weather radar obtained, from copolar and cross-polar channels. From the coherency matrix in Equation (3), radar variables are evaluated. From the two degrees of freedom on the diagonal, reflectivity (Z_{H}) and Linear Depolarization Ratio (LDR_{H}) can be extracted:

$$\begin{matrix}{Z}_{H} ∝ 〈 {\vert {s}_{hh} \vert}^{2} 〉 & ( 4 ) \\ {LDR}_{H} = \frac{〈 {\vert {s}_{vh} \vert}^{2} 〉}{〈 {\vert {s}_{hh} \vert}^{2} 〉} & ( 5 )\end{matrix}$$

Reflectivity is proportional to the power backscattered at horizontal polarization, and the linear depolarization ratio is representative of the target-induced coupling between copolar (i.e., horizontal) and cross-polar (i.e., vertical) channels. The two degrees of freedom on the off-diagonal term are captured by the cross-polar correlation coefficient ρₓₕ, and the cross-polar phase ψₓₕ, which is propagation φₓₕ plus back scatter δₓₕ:

$$\begin{matrix}{ρ}_{xh} = \frac{\vert 〈 {s}_{hh}^{*} {s}_{vh} 〉 \vert}{\sqrt{〈 {\vert {s}_{hh} \vert}^{2} 〉 〈 {\vert {s}_{vh} \vert}^{2} 〉}} & ( 6 ) \\ {ψ}_{xh} = {Φ}_{xh} + {δ}_{xh} - arg [ 〈 {s}_{hh}^{*} {s}_{vh} 〉 ] & ( 7 )\end{matrix}$$

The coherency matrix can be diagonalized by means of a similarity transformation to yield:

$$\begin{matrix} {J}_{H} = {U}_{2} [ \begin{matrix}{λ}_{H 1} & 0 \\ 0 & {λ}_{H 2}\end{matrix} ] {U}_{2}^{- 1} = {λ}_{H 1} {u}_{1} {u}_{1}^{+} + {λ}_{H 2} {u}_{2} {u}_{2}^{+} & ( 8 ) \\ {U}_{2} = [ {u}_{1} {u}_{2} ] = [ \begin{matrix}cos ξ {e}^{j μ} & sin {ξe}^{j v} \\ - sin {ξe}^{- j v} & cos ξ {e}^{- j μ}\end{matrix} ] & ( 9 ) \\ {J}_{H} = [ \begin{matrix}{λ}_{H 1} {cos}^{2} ξ + {λ}_{H 2} {sin}^{2} ξ & ( {λ}_{H 2} - {λ}_{H 1} ) sin ξcos {ξe}^{j ( μ + v )} \\ ( {λ}_{H 2} - {λ}_{H 1} ) sin ξcos {ξe}^{j ( μ + v )} & {λ}_{H 1} {sin}^{2} ξ + {λ}_{H 2} {cos}^{2} ξ\end{matrix} ] & ( 10 )\end{matrix}$$

As the two orthogonal unit eigenvectors note that

u₁u₁⁺+u₂u₂⁺=I (11)

where I is the identity matrix. The Chandrasekhar decomposition of the wave follows:

J_{H}=(λ_{H1}−λ_{H2})u₁u₁⁺+λ₂I=J_{CP}+J_{CD} (12)

This decomposition in Equation (12) states that any partially polarized wave (J_{H}) can be decomposed into a completely polarized wave (J_{CP}) and a completely unpolarized wave (J_{CD}). The eigenvector u₁ associated with the largest eigenvalue represents a fully polarized wave:

$${u}_{1} = [ \begin{matrix}cos ξ {e}^{j μ} \\ - sin ξ {e}^{- j v}\end{matrix} ] \qquad ( 13 )$$

The information contained in the two eigenvalues λ_{H1} and λ_{H2} can be encapsulated in two variables: trace and degree of polarization. Since these two variables. are eigenvalue derived, they are polarization basis invariant and, in particular, they are independent from the cross-polar phase, (μ+ν) in the parameterization in Equation (10).

The total backscattered power (the trace) is given by:

TrJ_{H}=λ_{H1}+λ_{H2}=<|sₕₕ|²>+<|sᵥₕ|²> (14)

The ratio of completely polarized power to total power (degree of polarization) is given by:

$${p}_{H} = \frac{{λ}_{H 1} - {λ}_{H 2}}{{λ}_{H 1} + {λ}_{H 2}} = \sqrt{1 - \frac{4 [ 〈 {\vert {s}_{hh} \vert}^{2} 〉 〈 {\vert {s}_{vh} \vert}^{2} 〉 - {\vert 〈 {s}_{hh} {s}_{vh}^{*} 〉 \vert}^{2} ]}{{[ 〈 {\vert {s}_{hh} \vert}^{2} 〉 + 〈 {\vert {s}_{vh} \vert}^{2} 〉 ]}^{2}}} \qquad ( 15 )$$

The trace and the degree of polarization are eigenvalue-derived variables and therefore: do have desirable properties, such as robustness to coherent antenna cross-channel coupling. They are related to standard radar meteorological variables by the following relations:

$$\begin{matrix}{TrJ}_{H} = {λ}_{H 1} + {λ}_{H 2} = {Z}_{H} [ 1 + L D {R}_{H} ] & ( 16 ) \\ ( 1 - {p}_{H}^{2} ) = \frac{4 L D {R}_{H}}{{[ 1 + L D {R}_{H} ]}^{2}} ( 1 - {ρ}_{xh}^{2} ) & ( 17 )\end{matrix}$$

For targets with reflection symmetry (such as, non-canted hydrometeors), ρₓₕ=0, and the relation in Equation (17) becomes:

$${p}_{H} = \frac{1 - {LDR}_{H}}{1 + {LDR}_{H}} \qquad ( 18 )$$

The relation in (18) can be inverted to obtain LDR_{H0}:

$$L D {R}_{H 0} ≡ \frac{1 - {p}_{H}}{1 + {p}_{H}} = \frac{{λ}_{H 2}}{{λ}_{H 1}} \qquad ( 19 )$$

LDR_{H0} is equal to the ratio of the minimum eigenvalue to the maximum eigenvalue of the coherency matrix. For scatterers with reflection symmetry, LDR_{H0} is equal to LDR_{H}, but has the distinctive advantage of not being biased by coherent antenna cross-channel coupling. From Equations (16) and (19) we obtain:

$${Z}_{H} [ 1 + L D {R}_{H} ] = {λ}_{H 1} [ 1 + \frac{{λ}_{H 2}}{{λ}_{H 1}} ] = {Z}_{H 0} [ 1 + L D {R}_{H 0} ] \qquad ( 20 )$$

This leads to the definition of reflectivity nought as the largest eigenvalue of the coherency matrix:

Z_{H0}≡λ_{H1} (21)

For scatterers with reflection symmetry, reflectivity nought is equal to standard reflectivity, but has the distinctive advantage of not being biased by coherent antenna cross-channel coupling.

For dual-pol radars transmitting vertical polarization, the coherency matrix at vertical transmission is measured. This matrix is equivalent to the lower right 2×2 minor of the backscatter covariance matrix:

$${J}_{V} = [ \begin{matrix}〈 {\vert {s}_{vv} \vert}^{2} 〉 & 〈 {s}_{vv}^{*} {s}_{hv} 〉 \\ 〈 {s}_{vv} {s}_{hv}^{*} 〉 & 〈 {\vert {s}_{hv} \vert}^{2} 〉\end{matrix} ] \qquad ( 22 )$$

From the coherency matrix in Equation (22), radar variables are evaluated From the two degrees of freedom on the diagonal, reflectivity (Z_{V}) and linear depolarization ratio (LCR_{V}) can be extracted:

$$\begin{matrix}{Z}_{V} ∝ 〈 {\vert {s}_{vv} \vert}^{2} 〉 & ( 23 ) \\ L D {R}_{V} = \frac{〈 {\vert {s}_{hv} \vert}^{2} 〉}{〈 {\vert {s}_{vv} \vert}^{2} 〉} & ( 24 )\end{matrix}$$

If λ_{V1} and λ_{V2} are used to represent the maximum and minimum eigenvalues, respectively of the coherency matrix at vertical polarization transmit, the same theoretical development as described above with respect to horizontal transmission leads to the definition of LDR_{V0} and Z_{V0}:

$$\begin{matrix}L D {R}_{V 0} ≡ \frac{1 - {p}_{V}}{1 + {p}_{V}} = \frac{{λ}_{V 2}}{{λ}_{V 1}} & ( 25 ) \\ {Z}_{V 0} ≡ {λ}_{V 1} & ( 26 )\end{matrix}$$

The combination of the results in Equations (21) and (26) yields the definition of differential reflectivity nought, which is an eigenvalue derived proxy for differential reflectivity available from radars with polarization agility on transmit and dual-polarization on receive (such as in fully polarimetric radars):

$${Z}_{DR 0} ≡ \frac{{Z}_{H 0}}{{Z}_{V 0}} = \frac{{λ}_{H 1}}{{λ}_{V 1}} \qquad ( 27 )$$

For dual-polarization radars transmitting circular polarization, the coherency matrix is:

$${J}_{C} = [ \begin{matrix}〈 {\vert {s}_{II} \vert}^{2} 〉 & 〈 {s}_{II}^{*} {s}_{r 1} 〉 \\ 〈 {s}_{II} {s}_{r 1}^{*} 〉 & 〈 {\vert {s}_{r 1} \vert}^{2} 〉\end{matrix} ] \qquad ( 28 )$$

From the coherency matrix in Equation (28), the reflectivity (Z_{C}) and the Circular Depolarization Ratio (CDR) can be extracted:

$$\begin{matrix}{Z}_{C} ∝ 〈 {\vert {s}_{r 1} \vert}^{2} 〉 & ( 29 ) \\ C D R = \frac{〈 {\vert {s}_{II} \vert}^{2} 〉}{〈 {\vert {s}_{r 1} \vert}^{2} 〉} & ( 30 )\end{matrix}$$

If λ_{C1} and λ_{C2} are used to represent the maximum and minimum eigenvalues, respectively, of the coherency matrix at circular polarization transmit, the same theoretical development as described above leads to the definition of CDR₀ and Z_{C0}.

$$\begin{matrix}C D {R}_{0} ≡ \frac{1 - {p}_{C}}{1 + {p}_{C}} = \frac{{λ}_{C 2}}{{λ}_{C 1}} & ( 31 ) \\ {Z}_{C 0} ≡ {λ}_{C 1} & ( 32 )\end{matrix}$$

In particular, CDR₀ is more robust than CDR with respect to coherent antenna cross-channel coupling. CDR₀ does not have the bias induced by the coherent antenna cross-channel coupling.

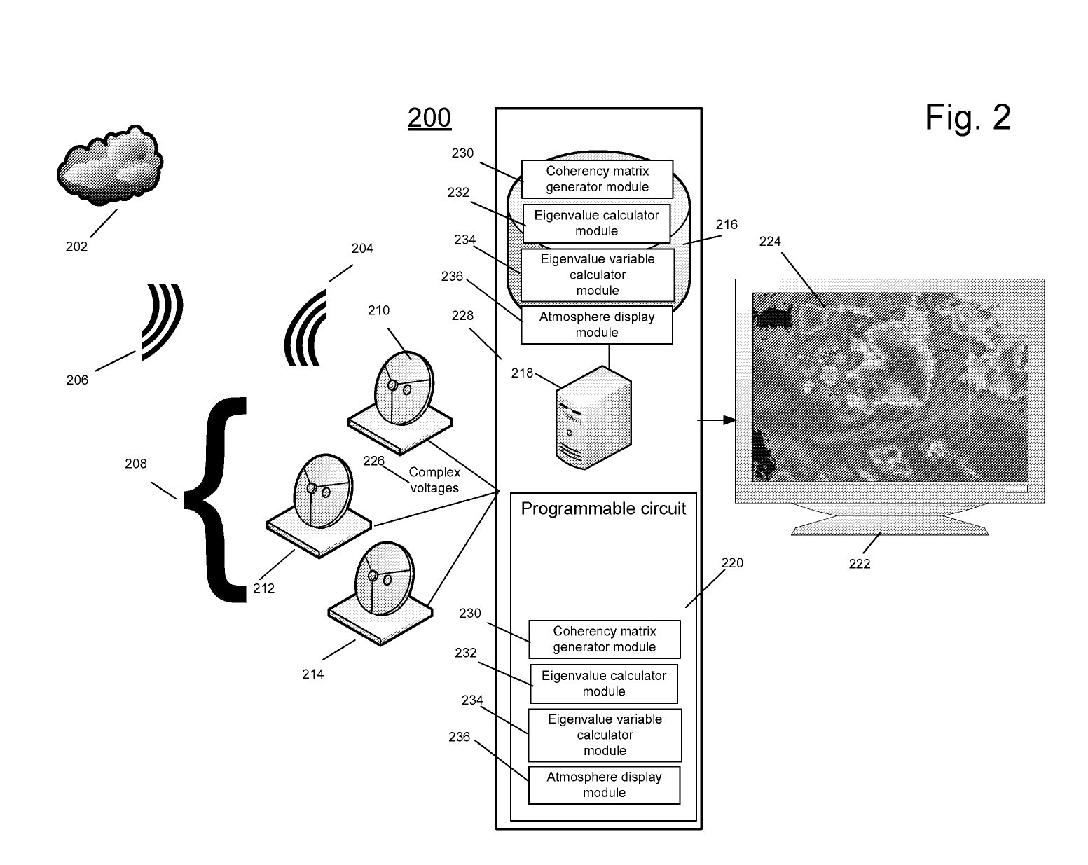

FIG. 2 illustrates an example of a system that can be utilized to implement an atmospheric radar arranged according to at least some embodiments described herein. System 200 includes a processor 228 configured to be in communication with an antenna array 208 and/or a display 222. Antenna array 208 may include antennas 210, 212, 214 capable of transmitting a transmitted wave 204. Each antenna may be a phased array antenna that may include many radiating elements. Transmitted wave 204 may include waves that are horizontally, vertically, and/or circularly polarized. Transmitted wave 204 may be incident upon an atmospheric target 202 that includes a meteorological property. Atmospheric target 202 may receive transmitted wave 204 and reflect back or backscatter a reflected wave 206. Reflected wave 206 may indicate meteorological properties of atmospheric target 202. Reflected wave 206 may comprise many waves and may include information that may be used to measure polarimetric scattering properties of atmospheric target 202.

Reflected wave 206 may be received by antenna array 208. Antenna array 208 may convert reflected wave 206 into complex voltages 226 and send complex voltages 226 to processor 228. Processor 228 may be implemented in software as shown with a hardware server 218 and memory 216. Processor 228 may be implemented as hardware as shown with programmable circuit 220. Programmable circuit 220 may be, for example, a field programmable gate array (FPGA) or an application specific integrated circuit (ASIC).

Processor 228 may include a coherency matrix generator module 230, an eigenvalue calculator module 232, an eigenvalue variable calculator module 234 and/or an atmosphere display module 236. Modules 230, 232, 234, and/or 236 may be implemented in software as shown in memory 216 or in hardware as shown in programmable circuit 220. Coherency matrix generator module 230 may receive complex voltages 226 that correspond to backscattered radar signal measurements of atmospheric target 202 and generate a coherency matrix. Eigenvalue calculator module 232 may receive the coherency matrix and calculate eigenvalues of the coherency matrix. Eigenvalue variable calculator module 234 may receive the eigenvalues and calculate eigenvalue meteorological variables. Atmosphere display module may receive the eigenvalue meteorological variables and generate an output signal 224 in response. Output signal 224 may correspond to meteorological properties of atmospheric target 202. Output signal 224 may be useful for post-processing, or for weather analysis and forecasting, such as analysis of precipitation rate, type, structure, and intensity. For example, the severity of precipitation of atmospheric target 202 may be represented in output signal 224 using different colors. Output signal 224 may be rendered by display 222.

Among other potential benefits, a system in accordance with this disclosure may be effective to solve a polarimetric cross-channel coupling problem that may be present in atmospheric radars. For atmospheric radars, whose frequencies may range from S (in Next-Generation Radar—NEXRAD) to C, to X to Ku, Ka, W and beyond, avoiding cross-channel coupling may be particular significance. For example, when one channel is excited, e.g., by H (horizontal) polarization, inevitably some power leaks in the cross-polar channel, V (vertical) polarization. In a weather radar, the polarimetric cross-channel coupling causes measurement bias for the meteorological variables used for weather analysis and forecasting. In using a system in accordance with the disclosure, measurement bias of meteorological variables caused by the polarimetric cross-channel coupling in antennas may be reduced or eliminated.

The disclosed method corrects the bias in polarimetric variables in a simple and inexpensive way. A system in accordance with the disclosure need not make the antenna polarimetrically pure. The cross-pol power is still generated, but a system in accordance with the disclosure may “realign” the H and V electric fields of the antenna by means of a diagonalization of the measured coherency matrices. The new set of meteorological variables is equivalent to the original set of standard polarimetric variables, but this time the variables are unbiased. With the disclosed method, a weather radar using an antenna with sub-optimal polarimetric isolation can still have the ability to detect a target's meteorological properties in a way comparable to a weather radar using higher performing antenna. The system need not radiate cross-polar power to reduce measurement bias. Apertures of antennas need not be modified.

The range of applications is broad, and encompasses both parabolic reflectors with sub-optimal polarimetric isolation as well as planar phased arrays scanning off boresight (such as beams with non-zero elevation and azimuth), in particular, millimeter-wave parabolic reflector antennas generally show poor cross-polarization isolation, essentially because at short wavelengths cross-polarization scattering from the feed support struts is more efficient than that at centimeter wavelengths.

Eigenvalue signal processing for the correction of antenna cross-polar bias may be used on scatterers that have reflection symmetry. Reflection symmetry is generally met by atmospheric scatterers. Weather surveillance radars in use in the US and Europe tend to use reflection symmetry and also low intrinsic target cross-polarization (namely, scatterers with low intrinsic LDR).

A system in accordance with the disclosure is applicable for radars operating at LDR mode (H transmit (“tx”), H and V receive (“rx”)). CDR mode (Circular tx, RHC and LHC Rx), or fully polarimetric radars with polarization agility on transmit and dual-polarization coherent receivers. The disclosed system may be a candidate for Multimission Phased-Array Radar (MPAR) implementation such as in examples where phased array weather radars replace the simultaneous transmission mode with an alternate transmission mode.

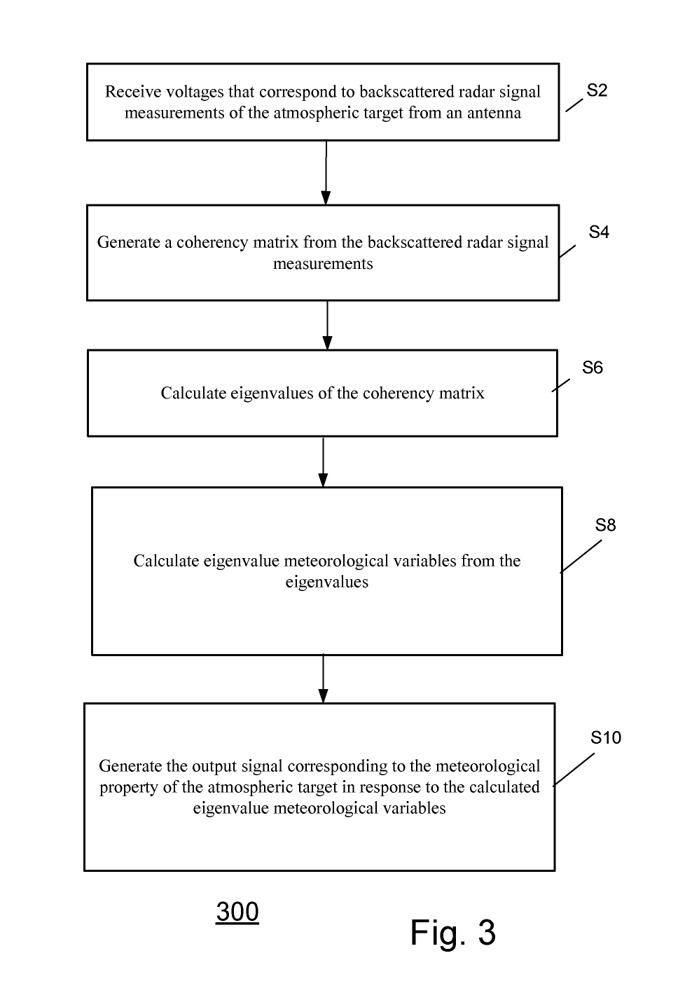

FIG. 3 depicts a flow diagram for an example of a process 300 for generating an output signal corresponding to a meteorological property of an atmospheric target in accordance with at least some embodiments described herein. The process in FIG. 3 could be implemented using, for example, system 200 discussed above. An example of a process may include one or more operations, actions, or functions as illustrated by one or more of blocks S2, S4, S6, S8 and/or S10.

Process 300 may begin at block S2, where a processor may receive voltages that correspond to backscattered radar signal measurements of an atmospheric target from an antenna. Processing may continue from block S2 to block S4, where the processor may generate a coherency matrix from the backscattered radar signal measurements. Processing may continue from block S4 to block S6, where the processor may calculate eigenvalues of the coherency matrix.

In an example, in response to receipt of the backscattered radar signal measurements from horizontal transmitted polarization, the processor will generate a coherency matrix J_{H} as shown in Equation (3), if variables at vertical transmission are to be calculated, the processor will generate coherency matrix J_{V} at vertical transmission using information or measurements of the received radar signals from the co-pol and cross-pol channels at vertical transmit.

Processing may continue from block S6 to block S8, where the processor may calculate the eigenvalue meteorological variables from the eigenvalues. Processing may continue from block S8 to block S10, where the processor may generate the output signal corresponding to the meteorological property of the atmospheric target in response to the calculated eigenvalue meteorological variables.

### EXAMPLE

Eigenvalue Signal Processing was tested for ZH_ESP (reflectivity at horizontal transmit), LDRH_ESP (linear depolarization ratio) and DOPH (degree of polarization at horizontal transmit) in an experiment conducted on Nov. 20, 2012 at Selex Gematronik facilities in Neuss, Nordrhein-Westfalen, Germany at around 16:20 local time, when ground temperature was +11° C. The parabolic reflector C-band radar acquired a PPI (Plan Position Indicator) at 1.5° elevation in a weather event including light stratiform rain, with a melting band visible as a low LDR ring around the radar at about 50 km distance.

The radar was operated at LDR mode, in two different configurations indicated with cc_on and cc_off. The cc_on acquisition was taken between 16:18:21.122 and 16119:40.826 CET (Central European Time), whereas the cc_off acquisition was taken between 16:19:40.826 and 16:21:00.643 CET. The two acquisitions are spaced in time by about 1.5 minutes, and it can reasonably be assumed that the illuminated scatterers are the same.

In the cc_off acquisition, the radar was operated in its standard. configuration, whereas in the cc_on acquisition, the detrimental effects of a suboptimal antenna were simulated by disconnecting the V transmit waveguide and by injecting into the Tx port of the V circulator a signal sample extracted from the H transmit channel via a 20 dB coupler.

The following plots correspond to radials at 352° azimuth, where light rain is present from 10 to 40 km and where wet aggregates (melting band) are present from 45 to 60 km.

A. Reflectivity at horizontal transmit ZH, in dBZ.
B. Reflectivity at vertical transmit ZV, in dBZ (cross-polar reflectivity, i.e. received in the V channel).
C. Cross-polar correlation coefficient, ρₓₕ.
D. Linear Depolariziaton Ratio DLR, in dB.
E. Linear Depolarization Ratio ESP corrected. Note how the coupled configuration yields results identical to the uncoupled configuration, that is, coherent cross-polar power is automatically removed.
F. Degree of Polarization at horizontal transmit. Since the degree of polarization can be expressed as a function of the eigenvalues of the coherency matrix at horizontal transmit, the degree of polarization automatically enjoys the properties of SU(2) (Special Unitary group of 2×2 matrices) invariance and is not affected by antenna cross-channel coupling.

In the plots from A to F, it can be observed how the coupled configuration affects variables that are not derived from the eigenvalues. For example, copolar reflectivity ZH (indeed, in this case the bias is very small and not directly visible from these plots), cross-polar reflectivity ZV, linear depolarization ratio (LDR) and cross-polar correlation coefficient (ρₓₕ) are affected. The variables that are eigenvalue-derived, the degree of polarization at horizontal transmit DOPH and LDRH_ESP, are unbiased by antenna cross-channel coupling.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method of generating an output signal corresponding to a meteorological property of an atmospheric target, the method comprising, by a processor:
receiving voltages that correspond to backscattered radar signal measurements of the atmospheric target from an antenna;
generating a coherency matrix from the voltages;
calculating eigenvalues of the coherency matrix;
calculating eigenvalue meteorological variables from the eigenvalues; and
generating the output signal that corresponds to the meteorological property of the atmospheric target in response to the calculated eigenvalue meteorological variables.

2. The method of claim 1, wherein generating the coherency matrix from the voltages comprises generating the coherency matrix from the voltages at horizontal polarization transmission.

3. The method of claim 1, wherein generating the coherency matrix from the voltages comprises generating the coherency matrix from the voltages at vertical polarization transmission.

4. The method of claim 1, wherein generating the coherency matrix from the voltages comprises generating the coherency matrix from the voltages at circular polarization transmission.

5. The method of claim 1, wherein the eigenvalue meteorological variables indicate reflectivity at horizontal transmit, reflectivity at vertical transmit, reflectivity at circular polarization transmit, differential reflectivity, linear depolarization ratio at horizontal transmit, linear depolarization ratio at vertical transmit, or circular depolarization ratio.

6. The method of claim 5, wherein the reflectivity at horizontal transmit is equal to a maximum eigenvalue of the coherency matrix generated at horizontal transmission.

7. The method of claim 5, wherein the reflectivity at vertical transmit is equal to a maximum eigenvalue of the coherency matrix generated at vertical transmission.

8. The method of claim 5, wherein the reflectivity at circular polarization transmit is equal to a maximum eigenvalue of the coherency matrix generated at circular polarization transmission.

9. The method of claim 5, wherein the differential reflectivity is equal to a ratio of a maximum eigenvalue of the coherency matrix generated at horizontal transmission, to a maximum eigenvalue of the coherency matrix generated at vertical transmission.

10. The method of claim 5, wherein the linear depolarization ratio at horizontal transmit is equal to a ratio of a maximum eigenvalue of the coherency matrix generated at horizontal transmission, to a minimum eigenvalue of the coherency matrix generated at horizontal transmission.

11. The method of claim 5, wherein the linear depolarization ratio at vertical transmit is equal to a ratio of a maximum eigenvalue of the coherency matrix generated at vertical transmission, to a minimum eigenvalue of the coherency matrix generated at vertical transmission.

12. The method of claim 5, wherein the circular depolarization ratio is equal to a ratio of a maximum eigenvalue of the coherency matrix generated at circular polarization transmission, to a minimum eigenvalue of the coherency matrix generated at circular polarization transmission.

13. The method of claim 1, further comprising rendering the output signal as a radar image on a display.

14. The method of claim 1, wherein the target has reflection symmetry.

15. A programmable circuit effective to generate an output signal that corresponds to a meteorological property of an atmospheric target, the programmable circuit comprising:
a coherency matrix generator module effective to receive voltages that correspond to backscattered radar signal measurements of the atmospheric target from an antenna and generate a coherency matrix;
an eigenvalue calculator module effective to receive the coherency matrix and calculate eigenvalues of the coherency matrix;
an eigenvalue variable calculator module effective to receive the eigenvalues and calculate eigenvalue meteorological variables from the eigenvalues; and
an atmosphere display module effective to receive the eigenvalue meteorological variables and generate the output signal that corresponds to the meteorological property of the atmospheric target in response.

16. The programmable circuit of claim 15, wherein the coherency matrix generator module, the eigenvalue calculator module, the eigenvalue variable calculator module, and the atmosphere display module are implemented in a field programmable gate array.

17. The programmable circuit of claim 15, wherein the coherency matrix generator module, the eigenvalue calculator module, the eigenvalue variable calculator module, and the atmosphere display module are implemented in an application specific integrated circuit.

18. An atmospheric radar system comprising:
an antenna array effective to transmit a wave toward an atmospheric target and receive a reflected wave in response, where the reflected wave includes voltages that correspond to backscattered radar signal measurements;
a display;
a processor configured to be in communication with the antenna array and the display;
where the processor includes
a coherency matrix generator module effective to receive the voltages and generate a coherency matrix;
an eigenvalue calculator module effective to receive the coherency matrix and calculate eigenvalues of the coherency matrix;
an eigenvalue variable calculator module effective to receive the eigenvalues and calculate eigenvalue meteorological variables from the eigenvalues; and
an atmosphere display module effective to receive the eigenvalue meteorological variables and generate an output signal that corresponds to the meteorological property of the atmospheric target based on the calculated eigenvalue meteorological variables;
the display effective to receive the output signal and render a displayed radar image in response.

19. The atmospheric radar system of claim 19, wherein the coherency matrix generator module, the eigenvalue calculator module, the eigenvalue variable calculator module, and the atmosphere display module are implemented in a field programmable gate array.

20. The programmable circuit of claim 19, wherein the coherency matrix generator module, the eigenvalue calculator module, the eigenvalue variable calculator module, and the atmosphere display module are implemented in an application specific integrated circuit.
